(19) United States
(12) Patent Application Publication
(10) Pub. No.: US 2010/0216045 A1
(43) Pub. Date: Aug. 26, 2010

(54) FUEL CELL SYSTEM AND CONTROL METHOD THEREOF

(75) Inventor: Makoto Ishibashi, Kariya-shi (JP)

Correspondence Address: KENYON & KENYON LLP, 1500 K STREET N.W., SUITE 700, WASHINGTON, DC, 20005, US

(73) Assignee: TOYOTA JIDOSHA KABUSHIKI KAISHA, Toyota-shi (JP)

(21) Appl. No.: 12/675,679

(22) PCT Filed: Aug. 11, 2008
(86) PCT No.: PCT/JP2008/064666

§ 371 Date: Feb. 26, 2010

(30) Foreign Application Priority Data
Aug. 29, 2007 (JP) 2007-222961

(51) Int. Cl. H01M 8/04

(52) U.S. Cl. 429/446

(57) ABSTRACT

Provided is a fuel cell system that can achieve a stable power generation state of a fuel cell after the fuel cell returns from an intermittent operation to a normal operation. The fuel cell system has: a fuel cell; a fuel gas system having a fuel gas supply flow path for flowing fuel gas supplied from a fuel supply source to the fuel cell; a variable pressure regulating valve that variably regulates the pressure of gas flowing through the fuel gas supply flow path; and a purge valve for exhausting gas from the fuel gas system, and the fuel cell system exhausts impurities in the fuel gas system to the outside through the purge valve after the fuel cell shifts from a power generation suspended state to a power generation state. The fuel cell system has a controller that, if an amount of impurities in the fuel gas system increases to exceed a predetermined amount during the power generation suspended state, controls, after the fuel cell shifts from the power generation suspended state to the power generation state, opening and closing action of the variable pressure regulating valve so that the fuel gas supplied to the fuel cell has a pressure greater than a predetermined reference value.

### TECHNICAL FIELD

The present invention relates to a fuel cell system and a control method thereof.

### BACKGROUND ART

Fuel cell systems having a fuel cell that is supplied with reactant gases (fuel gas and oxidant gas) and generates electric power have previously been developed and are in practical use. It is known that, in such fuel cell systems, impurities, e.g., nitrogen gas, arising from power generation accumulate over time inside of the fuel cell or in a fuel-off gas circulation flow path. In order to exhaust (purge) such impurities to the outside, a fuel cell system has currently been developed that has a purge valve disposed in an exhaust flow path connected to the circulation flow path and controls the opening and closing of the purge valve.

Also, a fuel cell system has currently been developed that has a secondary battery, such as a storage battery, in addition to the fuel cell, carries out an operation (intermittent operation) where power generation by the fuel cell is temporarily stopped, for example, if the system has a low load, and returns to a normal operation to restart power generation, for example, if the system has an increased load. In recent times, the technique of effectively exhausting impurities when the fuel cell is under an intermittent operation for a long time, by increasing the frequency of purging to be performed after the fuel cell returns from the intermittent operation to a normal operation, has also been developed (see, for example, Japanese laid-open patent publication No. 2007-26843).

### DISCLOSURE OF THE INVENTION

However, even by employing the above-mentioned technique described in Japanese laid-open patent publication No. 2007-26843, it may take a long time to exhaust impurities by purging. This may result in failing to achieve a stable power generation state of the fuel cell after the fuel cell returns from an intermittent operation to a normal operation.

The present invention has been made in light of the foregoing circumstances, and an object of the invention is to provide a fuel cell system that can achieve a stable power generation state of a fuel cell after the fuel cell returns from an intermittent operation to a normal operation.

In order to achieve the above object, a fuel cell system according to the present invention has: a fuel cell; a fuel gas system having a fuel gas supply flow path for flowing fuel gas supplied from a fuel supply source to the fuel cell; a variable pressure regulating valve that variably regulates pressure of gas that flows through the fuel gas supply flow path; and a purge valve for exhausting gas from the fuel gas system, and the fuel cell system exhausting impurities in the fuel gas system to the outside through the purge valve after the fuel cell shifts from a power generation suspended state to a power generation state. This fuel cell system has a controller that, if an amount of impurities in the fuel gas system increases to exceed a predetermined amount during the power generation suspended state, controls, after the fuel cell shifts from the power generation suspended state to the power generation state, opening and closing action of the variable pressure regulating valve so that the fuel gas supplied to the fuel cell has a pressure greater than a predetermined reference value.

Also, a fuel cell system control method according to the present invention is a method for controlling a fuel cell system having: a fuel cell; a fuel gas system having a fuel gas supply flow path for flowing fuel gas supplied from a fuel supply source to the fuel cell; a variable pressure regulating valve that variably regulates pressure of gas that flows through the fuel gas supply flow path; and a purge valve for exhausting gas from the fuel gas system, the fuel cell system exhausting impurities in the fuel gas system to the outside through the purge valve after the fuel cell shifts from a power generation suspended state to a power generation state, and this method includes the step of, if an amount of impurities in the fuel gas system increases to exceed a predetermined amount during the power generation suspended state, controlling, after the fuel cell shifts from the power generation suspended state to the power generation state, opening and closing action of the variable pressure regulating valve so that the fuel gas supplied to the fuel cell has a pressure greater than a predetermined reference value.

With the above configuration and method, if the amount of impurities in the fuel gas system increases to exceed a predetermined amount when the fuel cell is in a power generation suspended state, the pressure of the fuel gas to be supplied after the fuel cell shifts from the power generation suspended state to the power generation state can be set to a relatively high level (a value greater than a predetermined reference value). Accordingly, after the fuel cell shifts from the power generation suspended state to the power generation state, even if a relatively long time is required to exhaust the impurities in the fuel gas system, the power generation state of the fuel cell can be stabilized. Note that the “power generation suspended state” refers to a state where the power generation by the fuel cell is temporarily stopped, and the “power generation state” refers to a state where the fuel cell continues generating power.

In the above fuel cell system, the fuel gas system may be a fuel gas system having a circulation pump for circulating fuel-off gas exhausted from the fuel cell. In that case, the controller may be a controller that, after the fuel cell shifts from the power generation suspended state to the power generation state until the total volume of gas in the fuel gas system is replaced by means of the circulation pump, controls the opening and closing action of the variable pressure regulating valve so that the pressure of the fuel gas supplied to the fuel cell is maintained at a value greater than the predetermined reference value.

With the above configuration, after the fuel cell shifts from the power generation suspended state to the power generation state until the total volume of gas in the fuel gas system is replaced by means of the circulation pump (in other words, until the impurities are completely exhausted), the pressure of the fuel gas supplied to the fuel cell can be maintained at a relatively high level (a value greater than the predetermined reference value). Accordingly, the impurities accumulated during the power generation suspended state can be exhausted quickly and completely, and as a result, the power generation state of the fuel cell can be further stabilized.

Also, in the above fuel cell system, the variable pressure regulating valve may be an injector.

An injector is an electromagnetically-driven on-off valve capable of regulating a gas state (gas flow rate or pressure) by driving the valve body directly with an electromagnetic drive force at a predetermined drive cycle to separate the body from the valve seat. The valve body of the injector is driven by a predetermined control unit to control the timing and the length of time of the fuel gas injection, and consequently, the flow rate and pressure of the fuel gas can be controlled with high accuracy.

The present invention can provide a fuel cell system that can achieve a stable power generation state of a fuel cell after the fuel cell returns from an intermittent operation to a normal operation.

### BRIEF DESCRIPTION OF THE DRAWINGS

FIG. 1 is a configuration diagram of a fuel cell system according to an embodiment of the present invention.

FIG. 2 is a flowchart for explaining a control method for the fuel cell system shown in FIG. 1.

FIG. 3A is a time chart for explaining a control method for the fuel cell system shown in FIG. 1, illustrating the time history of an intermittent operation.

FIG. 3B is a time chart for explaining a control method for the fuel cell system shown in FIG. 1, illustrating the time history of an impurity partial pressure in a hydrogen gas system.

FIG. 3C is a time chart for explaining a control method for the fuel cell system shown in FIG. 1, illustrating the time history of a hydrogen pressure regulation value.

FIG. 3D is a time chart for explaining a control method for the fuel cell system shown in FIG. 1, illustrating the time history of a purging operation.

### BEST MODE FOR CARRYING OUT THE INVENTION

Hereinafter, a fuel cell system according to an embodiment of the present invention will be described with reference to the drawings. This embodiment explains the case where the present invention is used in an on-vehicle power generation system for a fuel cell vehicle (mobile object).

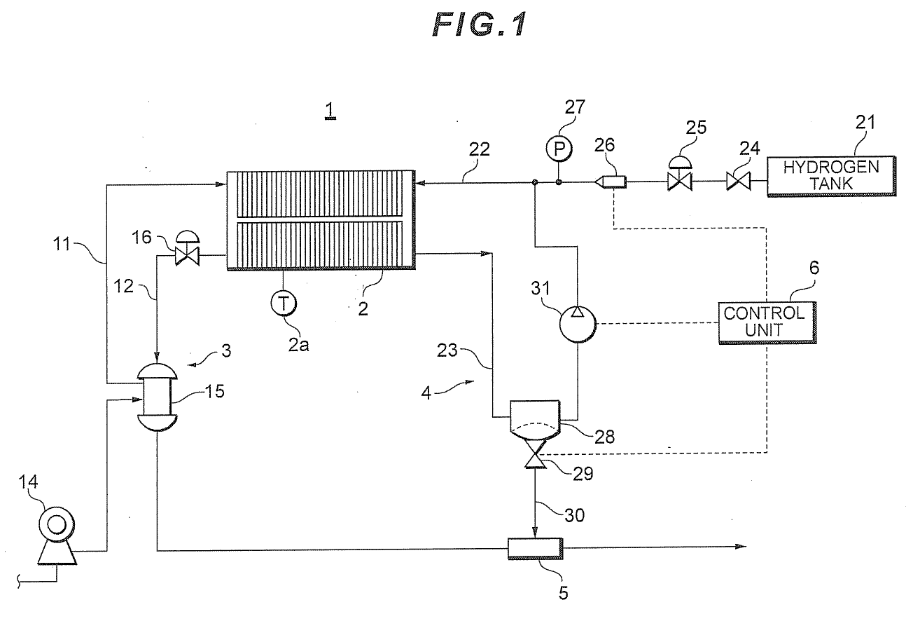

Referring first to FIG. 1, the configuration of a fuel cell system according to an embodiment of the present invention is described.

As shown in FIG. 1, a fuel cell system 1 according to this embodiment has a fuel cell 2 that is supplied with reactant gases (oxidant gas and fuel gas) and generates electric power. The fuel cell 2 is connected to an oxidant gas system 3 for supplying the fuel cell 2 with air as oxidant gas and exhausting oxidant-off gas from the fuel cell 2, and also to a fuel gas system 4 for supplying the fuel cell 2 with hydrogen gas as fuel gas and circulating hydrogen-off gas being fuel-off gas, as well as hydrogen gas, into the fuel cell 2. The fuel gas system 4 has an exhaust/drain valve 29 capable of exhausting hydrogen-off gas from the fuel gas system 4. The hydrogen-off gas exhausted from the exhaust/drain valve 29 is mixed, in a diluter 5, with oxidant-off gas (air) exhausted from the oxidant gas system 3, and exhausted to the outside. A control unit 6 performs overall control of the entire system.

The fuel cell 2 is, for example, a solid polymer electrolyte-type fuel cell, and has a stack structure of a number of layered unit cells. The unit cell of the fuel cell 2 has: an air electrode (cathode) on one surface of the solid polymer electrolyte membrane; a fuel electrode (anode) on the other surface; and a pair of separators arranged to sandwich the air electrode and the fuel electrode therebetween. The fuel cell 2 generates power when fuel gas is supplied to the flow path of the anode side separator and oxidant gas is supplied to the flow path of the cathode side separator.

The oxidant gas system 3 has an air supply flow path 11 through which the oxidant gas to be supplied to the fuel cell 2 flows, and an exhaust flow path 12 through which the oxidant-off gas exhausted from the fuel cell 2 flows. The air supply flow path 11 has a compressor 14 that takes in oxidant gas, and a humidifier 15 that humidifies pressurized oxidant gas transmitted from the compressor 14. The exhaust flow path 12 has a back-pressure regulating valve 16, and is connected to the humidifier 15. The oxidant-off gas flowing through the exhaust flow path 12 goes through the back-pressure regulating valve 16 to the humidifier 15, where the oxidant-off gas is subjected to moisture exchange, and then is transferred to the dilutor 5.

The fuel gas system 4 has: a hydrogen tank 21 that stores high-pressure hydrogen gas and serves as a fuel supply source; a hydrogen supply flow path 22 serving as a fuel gas supply flow path for supplying hydrogen gas in the hydrogen tank 21 to the fuel cell 2; and a circulation flow path 23 for returning the hydrogen-off gas exhausted from the fuel cell 2 back to the hydrogen supply flow path 22. Note that, instead of the hydrogen tank 21, a reformer that generates a hydrogen-rich reformed gas from a hydrocarbon-type fuel and a high-pressure gas tank in which the reformed gas generated by this reformer is accumulated under high pressure may also be used as a fuel supply source. Alternatively, a tank with a hydrogen-absorbing alloy may also be used as a fuel supply source.

The hydrogen supply flow path 22 is provided with a cutoff valve 24 that blocks or allows the supply of hydrogen gas from the hydrogen tank 21, a regulator 25 that regulates the pressure of hydrogen gas, and an injector 26. Also, a pressure sensor 27 that detects the pressure of hydrogen gas in the hydrogen supply flow path 22 is provided downstream of the injector 26 and upstream of the meeting point of the hydrogen supply flow path 22 and the circulation flow path 23. Information concerning the hydrogen gas pressure detected by the pressure sensor 27 is transmitted to the control unit 6 and used for control of a hydrogen circulation system.

The regulator 25 is a device for regulating the upstream pressure (primary pressure) to a predetermined secondary pressure. In this embodiment, a mechanical pressure-reducing valve that reduces the primary pressure is used as the regulator 25. As for the configuration of the mechanical pressure-reducing valve, a known configuration may be used, wherein the valve has a casing in which a back-pressure chamber and a pressure control chamber are formed to be separated by a diaphragm, and the valve reduces the primary pressure to a predetermined pressure being a secondary pressure in the pressure control chamber utilizing the back pressure within the back-pressure chamber.

The injector 26 is an electromagnetically-driven on-off valve that can regulate a gas flow rate or gas pressure by driving the valve body directly with an electromagnetic drive force at a predetermined drive cycle and separating it from the valve seat. As shown in FIG. 1, in this embodiment, the injector 26 is provided upstream of the meeting point of the hydrogen supply flow path 22 and the circulation flow path 23. The injector 26 has a valve seat having an injection outlet for injecting a gaseous fuel such as hydrogen gas, and the injector 26 also has a nozzle body for supplying and guiding the gaseous fuel towards the injection outlet, and a valve body contained in the nozzle body such that it can move in the axial direction of the nozzle body (gas flow direction) to open and close the injection outlet. In this embodiment, the valve body of the injector 26 is driven by a solenoid, which is an electromagnetic driving device. By performing on/off control of the pulsed exciting current to be supplied to the solenoid and thereby driving the valve body, the opening area of the injection outlet can be changed between two or more levels. The length of time and the timing of the gas injection from the injector 26 is controlled by control signals output from the control unit 6. With the above configuration, the hydrogen gas flow rate and pressure can be controlled with high accuracy. Since the injector 26 directly drives and opens/closes the valve (valve seat and valve body) with an electromagnetic drive force and can control the drive cycle of the valve to a high-response level, the injector 26 has a high responsivity.

The injector 26 regulates the flow rate of the gas (or molar concentration of hydrogen) to be supplied to the downstream thereof (the fuel cell 2 side). More specifically, in order to supply a required flow rate of gas to the downstream thereof, the injector 26 changes the opening area (opening degree) of the valve, which is provided in the gas flow path of the injector 26, or the length of time of opening the valve, or both. By opening and closing the valve of the injector 26, the gas flow rate is regulated and the pressure of the gas to be supplied to the downstream of the injector 26 is reduced relative to the gas pressure upstream of the injector 26, and thus, the injector 26 may be deemed as a pressure regulating valve (pressure reducing valve, regulator). Furthermore, in this embodiment, the injector 26 also functions as a variable pressure regulating valve that can change the amount of pressure control (pressure reduction) for its upstream gas pressure, within a predetermined pressure range, depending on the required gas, so as to meet the required pressure.

The circulation flow path 23 is connected to an exhaust flow path 30 via a gas-liquid separator 28 and an exhaust/drain valve 29. The gas-liquid separator 28 collects water from the hydrogen-off gas. The exhaust/drain valve 29 operates in response to the commands from the control unit 6 and discharges (purges) the water collected by the gas-liquid separator 28 and the hydrogen-off gas (fuel-off gas) containing impurities in the circulation flow path 23, to the outside, and the exhaust/drain valve 29 serves as an embodiment of the purge valve according to the present invention. As a result of the purging as above, the amount of impurities (impurity partial pressure and impurity concentration) is reduced and the concentration of the hydrogen gas to be supplied to the fuel cell 2 is increased. The impurity partial pressure herein means the sum of the partial pressures of gases other than hydrogen gas, e.g., nitrogen gas contained in the hydrogen gas supplied from the hydrogen tank 21, nitrogen gas supplied from the oxidant gas system 3 to the fuel gas system 4, passing through the solid polymer electrolyte membrane, water vapor resulting from the power generation by the fuel cell 2, and the like. Also, the circulation flow path 23 is provided with a circulation pump 31 for pressurizing the hydrogen-off gas in the circulation flow path 23 and transmitting it towards the hydrogen supply flow path 22. Note that in the diluter 5, the hydrogen-off gas that is exhausted through the exhaust/drain valve 29 and the exhaust flow path 30 joins the oxidant-off gas in the exhaust flow path 12, and is diluted there.

The control unit 6 detects a manipulated amount of an accelerating member (e.g., accelerator) provided in the vehicle, receives control information, such as a required amount of acceleration (for example, a power generation amount required by a load device such as a traction motor), and controls the operation of various devices in the system. Note that the term load device is used herein as a general term of power-consuming devices including, other than the traction motor, auxiliary devices necessary for the operation of the fuel cell 2 (e.g., motors for the compressor 14 and the circulation pump 31), actuators used in various devices related to driving a vehicle (transmission, wheel controller, steering device, suspension, etc.), and an air conditioning device (air conditioner), lighting device, audio system, etc., for passenger space.

The control unit 6 is constituted by a computer system not shown in the drawing. The computer system has a CPU, ROM, RAM, HDD, I/O interface, display, etc. The CPU reads various control programs stored in the ROM and executes desired calculations, and as a result, the computer system carries out various types of processing and controls, including purging control explained later.

More specifically, the control unit 6 performs switching between a normal operation mode and an intermittent operation mode. The normal operation mode means an operation mode where the fuel cell 2 continues generating power to supply power to the load devices such as the traction motor. The intermittent operation mode means an operation mode where, during a low load operation, such as idling, low-speed driving and regenerative braking, the power generation by the fuel cell 2 is temporarily stopped, the load devices are supplied with power from a power storage device such as a battery and a capacitor, and the fuel cell 2 is intermittently supplied with hydrogen gas and air such that the fuel cell 2 can maintain an open-circuit voltage. The normal operation mode corresponds to a power generation state in the present invention, and the intermittent operation mode corresponds to a power generation suspended state in the present invention.

The control unit 6 also estimates an increase in the amount of impurities in the fuel gas system 4 while the fuel gas 2 is in an intermittent operation. If the estimated increase in the amount of impurities exceeds a predetermined amount, the control unit 6 controls, after the fuel cell 2 shifts from an intermittent operation mode to a normal operation mode, the opening/closing action of the injector 26 so as to increase the pressure of the hydrogen gas supplied to the fuel cell 2. In that control, the control unit 6 maintains the increased hydrogen gas pressure after the fuel cell 2 shifts from an intermittent operation mode to a normal operation mode until the total volume of gas in the fuel gas system 4 is replaced by means of the circulation pump 31. In other words, the control unit 6 serves as a controller in the present invention.

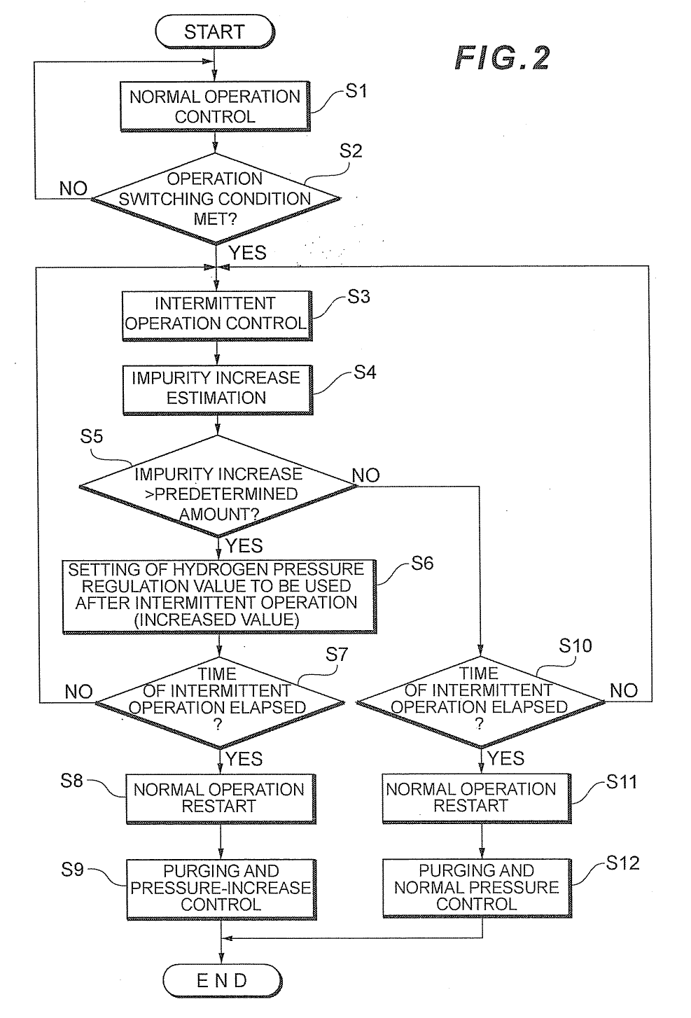

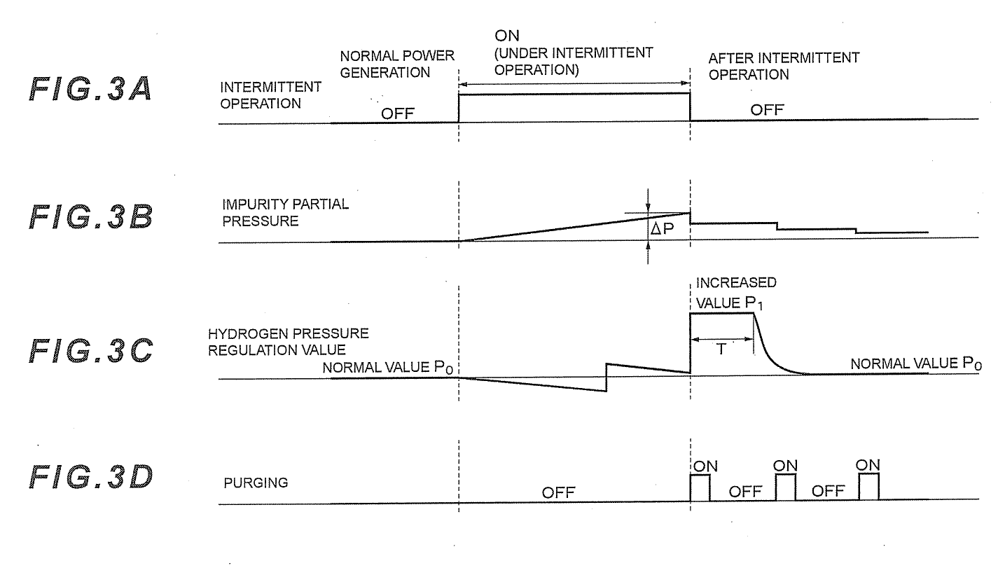

Referring next to the flowchart shown in FIG. 2 and the time charts shown in FIG. 3, the control method for the fuel cell system 1 according to this embodiment will be described.

The control unit 6 sets, upon activation, etc., system conditions based on the configuration of the fuel cell 2. Examples of the system conditions include: a solid polymer electrolyte membrane effective area, which is obtained by multiplying the effective area of the solid polymer electrolyte membrane of each unit cell in the fuel cell 2 by the number of the unit cells; and nitrogen gas permeability per unit area of the solid polymer electrolyte membrane. After the activation, the control unit 6 performs a control for achieving a normal operation mode (normal operation control step: S1).

In the normal operation control step S1, the control unit 6 regulates the oxidant gas and hydrogen gas by controlling various devices so that a required amount of power is generated by the fuel cell 2. The regulation of the oxidant gas is enabled, for example, by controlling the rotation frequency of the compressor 14 in the oxidant gas system 3 and regulating the back pressure of the oxidant-off gas exhausted from the fuel cell 2. The regulation of the hydrogen gas is enabled, for example, by controlling the cutoff valve 24 and the injector 26 in the fuel gas system 4, controlling the rotation frequency of the circulation pump 31, and controlling the exhaust/drain valve 29.

After that, the control unit 6 determines whether a condition of switching the operation mode of the fuel cell 2 from a normal operation mode to an intermittent operation mode (operation switching condition) is met or not (intermittent operation start determination step S2). As the operation switching condition, for example, the state where the required amount of power or the amount of power generation, which varies over time, goes below a predetermined threshold value may be applied. If the control unit 6 determines, in the intermittent operation start determination step S6, that the operation switching condition is met, the control unit 6 switches the operation mode of the fuel cell 2 from a normal operation mode to an intermittent operation mode as shown in FIG. 3A (intermittent operation control step: S3). In the intermittent operation control step S3, the control unit 6 temporarily stops the power generation by the fuel cell 2, supplies the load devices with power from a power storage device, and intermittently supplies the fuel cell 2 with hydrogen gas and air such that the fuel cell 2 can maintain an open-circuit voltage.

When the intermittent operation mode is carried out and the power generation by the fuel cell 2 is temporarily stopped, the amount of impurities in the fuel gas system 4 increases over time. For example, depending on the nitrogen gas permeability of the solid polymer electrolyte membrane in the fuel cell 2, nitrogen gas derived from the remaining air in the oxidant gas system 3 goes into the fuel gas system 4, increasing the nitrogen gas partial pressure there. Thus, the control unit 6 estimates an increase in the amount of impurities in the fuel gas system 4 during the intermittent operation, and if the estimated increase in the amount of impurities exceeds a predetermined amount, the control unit 6 increases a hydrogen pressure regulation value (a target pressure value of the hydrogen gas to be supplied to the fuel cell 2) to be used at the end of the intermittent operation mode.

In this embodiment, as shown in FIG. 3B, the control unit 6 estimates an increase ΔP in the impurity partial pressure in the fuel gas system 4 during the intermittent operation (impurity increase estimation step: S4). The impurity partial pressure refers to the partial pressure of all gases other than hydrogen gas in the fuel gas system 4, and it can be estimated mainly based on nitrogen gas partial pressure and water vapor partial pressure. The nitrogen gas partial pressure can be calculated mainly from the amount of nitrogen contained in the hydrogen gas supplied from the hydrogen tank 21 and the amount of nitrogen that penetrates from the cathode side to the anode side. The water vapor partial pressure can be estimated from the saturated water vapor pressure at the temperature of the fuel cell 2.

Next, the control unit 6 determines whether the increase ΔP in the impurity partial pressure estimated in the impurity increase estimation step S4 exceeds a predetermined value or not (impurity increase determination step: S5). If the control unit 6 determines in the impurity increase determination step S5 that the increase ΔP in the impurity partial pressure exceeds the predetermined value, the control unit 6 sets the hydrogen pressure regulation value to be used at the end of the intermittent operation mode to a value (increased value P₁) that goes over a normal value (predetermined reference value) P₀, as shown in FIG. 3C (hydrogen pressure regulation value setting step: S6). In this embodiment, the increased value P₁ corresponding to the estimated increase ΔP in the impurity partial pressure is set by using a predetermined map.

Subsequent to the hydrogen pressure regulation value setting step S6, the control unit 6 determines whether the time of intermittent operation has elapsed or not (intermittent operation end determination step: S7), and if the control unit 6 determines that the time of intermittent operation has elapsed, the control unit 6 ends the intermittent operation mode and shifts to the normal operation mode as shown in FIG. 3A (normal operation restart step: S8). After that, as shown in FIG. 3D, the control unit 6 opens the exhaust/drain valve 28 to exhaust (purge) the impurity-containing gas that remains in the fuel gas system 4, and controls the injector 26 so that the hydrogen gas pressure value detected by the pressure sensor 27 becomes equal to the hydrogen pressure regulation value (increased value P₁) set in the hydrogen pressure regulation value setting step S6 (purging and pressure-increase control step: S9).

In the purging and pressure-increase control step S9, the control unit 6 maintains the hydrogen gas pressure at the increased value P₁ immediately after the end of the intermittent operation mode until a specific period of time T has passed (immediately after the end of the intermittent mode until the total volume of gas in the fuel gas system 4 is replaced by means of the circulation pump 31), as shown in FIG. 3C. After the specific period of time T has passed, the control unit 6 controls the injector 26 to return the hydrogen gas pressure to the normal value P₀. Note that the hydrogen gas exhausted as a result of purging is diluted in the diluter 5 using the oxidant-off gas. After that, the control unit 6 continues purging until a predetermined purging condition (in particular, purging time) is met, and when the purging condition is met, the control unit 6 stops purging and ends the entire control operation.

Meanwhile, if the control unit 6 determines in the impurity increase determination step S5 that the increase ΔP in the impurity partial pressure is equal to or lower than the predetermined value, the control unit 6 determines whether the time of intermittent operation has elapsed or not (intermittent operation end determination step: S10), by keeping the hydrogen pressure regulation value to be used at the end of the intermittent operation mode at the normal value (predetermined reference value) P₀. If the control unit 6 determines that the time of intermittent operation has elapsed, the control unit 6 ends the intermittent operation mode and shifts to the normal operation mode (normal operation restart step: S11). After that, the control unit performs purging and normal pressure control (purging and normal pressure control step: S12).

In the fuel cell system 1 according to the above-described embodiment, if the amount of impurities in the fuel gas system 4 increases to exceed a predetermined amount during an intermittent operation mode, the pressure of the hydrogen gas to be supplied after the intermittent operation mode shifts to a normal operation mode can be set to be a relatively high pressure (value P₁ that is greater than the predetermined reference value P₀). Accordingly, after an intermittent operation mode shifts to a normal operation mode, even if a relatively long time is required to exhaust the impurities in the fuel gas system 4, the power generation state of the fuel cell 2 can be stabilized.

Also, in the fuel cell system 1 according to the above-described embodiment, immediately after the end of an intermittent operation mode until the total volume of gas in the fuel gas system 4 is replaced by means of the circulation pump 31 (in other words, until the impurities are completely exhausted), the pressure of the hydrogen gas supplied to the fuel cell 2 can be maintained at a relatively high level (value P₁ that is greater than the predetermined reference value P₀). Accordingly, the impurities accumulated during the intermittent operation can be exhausted quickly and completely, and as a result, the power generation state of the fuel cell 2 can be further stabilized.

While the above embodiment explains the case where the exhaust/drain valve 29 that enables both exhausting and draining is provided as a purge valve in the circulation flow path 23, a drain valve for removing water recovered by the gas-liquid separator 28 to the outside and an exhaust valve (purge valve) for exhausting gas within the circulation flow path 23 to the outside may be provided separately, and the control unit 6 may control the exhaust valve.

While the above embodiment explains the case where an “impurity partial pressure” is used as the amount of impurities in the fuel gas system 4, other physical values (e.g., an “impurity concentration”) may also be used. When using an “impurity concentration” as the amount of impurities, the control unit estimates an increase in the “impurity concentration” in the fuel gas system 4 during the intermittent operation, and if the estimated increase in the impurity concentration exceeds a predetermined amount, the control unit increases the hydrogen pressure regulation value to be used at the end of the intermittent operation mode.

While the above embodiment explains the case where a fuel cell vehicle is equipped with the fuel cell system according to the present invention, various mobile objects other than fuel cell vehicles (robots, ships, airplanes, etc.) can also be equipped with the fuel cell system according to the present invention. Furthermore, the fuel cell system according to the present invention can also be utilized in fixed power generation systems used as power generation equipment in constructions (houses, buildings, etc.).

### INDUSTRIAL APPLICABILITY

The fuel cell system according to the present invention can achieve a stable power generation state of a fuel cell after the fuel cell returns from an intermittent operation to a normal operation.

1. A fuel cell system comprising:
a fuel cell;
a fuel gas system having a fuel gas supply flow path for flowing fuel gas supplied from a fuel supply source to the fuel cell; and having a circulation pump for circulating fuel-off gas exhausted from the fuel cell;
a variable pressure regulating valve that variably regulates pressure of gas that flows through the fuel gas supply flow path;
a purge valve for exhausting gas from the fuel gas system;
a controller that controls the fuel cell to be switched between a power generation state and a power generation suspended state in which: power generation by the fuel cell is temporarily stopped; a load device is supplied with power from a power storage device; and the fuel cell is intermittently supplied with enough fuel gas to maintain an open-circuit voltage, the controller exhausting impurities in the fuel gas system to the outside through the purge valve after the fuel cell shifts from a power generation suspended state to a power generation state,
wherein if an amount of impurities in the fuel gas system increases to exceed a predetermined amount during the power generation suspended state, the controller controls, after the fuel cell shifts from the power generation suspended state to the power generation state, opening and closing action of the variable pressure regulating valve so that the fuel gas supplied to the fuel cell has a pressure greater than a predetermined reference value, and after the fuel cell shifts from the power generation suspended state to the power generation state until the total volume of gas in the fuel gas system is replaced by means of the circulation pump, the controller controls the opening and closing action of the variable pressure regulating valve so that the pressure of the fuel gas supplied to the fuel cell is maintained at a value greater than the predetermined reference value.

2. (canceled)

3. The fuel cell system according to claim 1, wherein the variable pressure regulating valve is an injector.

4. A method for controlling a fuel cell system having: a fuel cell; a fuel gas system having a fuel gas supply flow path for flowing fuel gas supplied from a fuel supply source to the fuel cell; and having a circulation pump for circulating fuel-off gas exhausted from the fuel cell; a variable pressure regulating valve that variably regulates pressure of gas that flows through the fuel gas supply flow path; and a purge valve for exhausting gas from the fuel gas system, the fuel cell system controlling the fuel cell to be switched between a power generation state and a power generation suspended state in which: power generation by the fuel cell is temporarily stopped; a load device is supplied with power from a power storage device; and the fuel cell is intermittently supplied with enough fuel gas to maintain an open-circuit voltage, and exhausting impurities in the fuel gas system to the outside through the purge valve after the fuel cell shifts from the power generation suspended state to the power generation state, the method comprising:
if an amount of impurities in the fuel gas system increases to exceed a predetermined amount during the power generation suspended state, controlling, after the fuel cell shifts from the power generation suspended state to the power generation state, opening and closing action of the variable pressure regulating valve so that the fuel gas supplied to the fuel cell has a pressure greater than a predetermined reference value,
wherein the controlling step includes controlling, after the fuel cell shifts from the power generation suspended state to the power generation state until the total volume of gas in the fuel gas system is replaced by means of the circulation pump, the opening and closing action of the variable pressure regulating valve so that the pressure of the fuel gas supplied to the fuel cell is maintained at a value greater than the predetermined reference value.
